(19) United States
(12) Patent Application Publication
(10) Pub. No.: US 2009/0144220 A1
(43) Pub. Date: Jun. 4, 2009

(54) SYSTEM FOR STORING DISTRIBUTED HASHTABLES

(75) Inventors: Andrew A. Feng, Cupertino, CA (US); Michael Bigby, San Jose, CA (US); Bryan Call, San Jose, CA (US); Brian F. Cooper, San Jose, CA (US); Daniel Weaver, Redwood City, CA (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 11/948,236

(22) Filed: Nov. 30, 2007

(51) Int. Cl. G06F 17/30

(52) U.S. Cl. 707/1; 707/E17.052

(57) ABSTRACT

A system for storing a distributed hash table. The system includes a storage unit, a tablet controller, a router, and a transaction bank. The storage unit has a plurality of tablets forming a hash table and each of the tablets includes multiple records. The tablet controller maintains a relationship between each tablet and the storage unit. The router hashes a record's key to determine the tablet associated with each record. Further, the router distributes messages from clients to the storage units based on the tablet-storage unit relationship thereby serving as a layer of indirection. The transaction bank propagates updates made in one record to all other replicas of the record.

### BACKGROUND

1. Field of the Invention

The present invention generally relates to an improved distributed database system using hash tables.

2. Description of Related Art

Very large scale mission-critical databases may be managed by multiple servers, and are often replicated to geographically scattered locations. In one example, a user database may be maintained for a web based platform, containing user logins, authentication credentials, preference settings for different services, mailhome location, and so on. The database may be accessed indirectly by every user logged into any web service. To improve continuity and efficiency, a single replica of the database may be horizontally partitioned over hundreds of servers, and replicas are stored in datacenters in the U.S., Europe and Asia.

In such a widely distributed database, achieving consistency for updates while preserving high performance may be a significant problem. Strong consistency protocols based on two-phase-commit, global locks, or read-one-write-all protocols introduce significant latency as messages must criss-cross wide-area networks in order to commit updates.

Other systems attempt to disseminate updates via a messaging layer that enforces a global ordering but such approaches do not scale to the message rate and global distribution required. Moreover, ordered messaging scenarios have more overhead than is required to serialize updates to a single record and not across the entire database. Many existing systems use gossip-based protocols, where eventual consistency is achieved by having servers synchronize in a pair-wise manner. However, gossip-based protocols require efficient all-to-all communication and are not optimized for an environment in which low-latency clusters of servers are geographically separated and connected by high-latency, long-haul links.

In view of the above, it is apparent that there exists a need for an improved distributed database system.

### SUMMARY

In satisfying the above need, as well as overcoming the drawbacks and other limitations of the related art, the present invention provides an improved database system for storing distributed hash tables.

In one aspect, the system includes a storage unit, a tablet controller, a router, and a transaction bank. The storage unit has a plurality of tablets forming a hash table and each of the tablets includes multiple records. The tablet controller maintains a relationship between each tablet and the storage unit. The router hashes a record's key to determine the tablet associated with each record. Further, the router distributes messages from clients to the storage units based on the tablet-storage unit relationship thereby serving as a layer of indirection. The transaction bank propagates updates made in one record to all other replicas of the record stored in other datacenters located in other regions.

In another aspect of the invention, each record includes a field indicating a master region for that record. As such, when the storage unit executes a put operation, the storage unit identifies the master region for that record and forwards the update to another router in the master region, if the storage unit is not in the master region. Alternatively, the storage unit may update the record and post the update to a transaction bank, if the storage unit is in the master region.

In another aspect of the invention, the router cashes a tablet-storage unit mapping to provide quick access to the tablets on each storage unit. the router may periodically poll the tablet controller to retrieve a new tablet-storage unit mapping, and/or the router may retrieve a new tablet-storage unit mapping if the storage unit returns an error to the router.

In another aspect of the present invention, the storage unit applies updates to a master record and serializes the update before disseminating the update to other replicas. Further, the storage unit commits updates by publishing the update to a transaction bank. As such, the storage unit serializes all writes to the record by assigning a sequence number to ensure that all replicas of the record apply update in the same order. Further, the storage unit commits updates locally in a record and then asynchronously copies updates to other replicas of the record.

For improved performance, the system uses an asynchronous replication protocol. As such, updates can commit locally in one replica, and are then asynchronously copied to other replicas. Even in this scenario, the system may enforce a weak consistency. For example, updates to individual database records must have a consistent global order, though no guarantees are made about transactions which touch multiple records. If is not acceptable in many applications if writes to the same record in different replicas, applied in different orders, cause the data in those replicas to become inconsistent.

Instead, the system may use a master/slave scheme, where all updates are applied to the master (which serializes them) before being disseminated over time to other replicas. One issue revolves around the granularity of mastership that is assigned to the data. The system may not be able to efficiently maintain an entire replica of the master, since any update in a non-master region would be sent to the master region before committing, incurring high latency. Systems may group records into blocks, which form the basic storage units, and assign mastership on a block-by-block basis. However, this approach incurs high latency as well. In a given block, there will be many records, some of which represent users on the east coast of the U.S., some of which represent users on the west coast, some of which represent users in Europe, and so on. If the system designates the west coast copy of the block as the master, west coast updates will be fast but updates from all other regions will be slow. The system may group geographically “nearby” records into blocks, but it is difficult to predict in advance which records will be written in which region, and the distribution might change over time. Moreover, administrators may prefer another method of grouping records into blocks, for example ordering or hashing by primary key.

In one embodiment, the system may assign master status to individual records, and use a reliable publish-subscribe (pub/sub) middleware to efficiently propagate updates from the master in one region to slaves in other regions. Thus, a given block that is replicated to three datacenters A, B, and C can contain some records whose master datacenter is A, some records whose master is B, and some records whose master is C. Writes in the master region for a given record are fast, since they can commit once received by a local pub/sub broker, although writes in the non-master region still incur high latency. However, for an individual record, most writes tend to come from a single region (though this is not true at a block or database level.) For example, in some user databases most interactions with a west coast user are handled by a datacenter on the west coast. Occasionally other datacenters will write that user's record, for example if the user travels to Europe or uses a web service that has only been deployed on the east coast. The per-record master approach makes the common case (writes to a record in the master region) fast, while making the rare case (writes to a record from multiple regions) correct in terms of the weak consistency constraint described above.

Accordingly, the system may be implemented with per-record mastering and reliable pub/sub middleware in order to achieve high performance writes to a widely replicated database. Several significant challenges exist in implementing distributed per-record mastering. Some of these challenges include:

The need to efficiently change the master region of a record when the access pattern changes

The need to forcibly change the master region of a record when a storage server fails

The need to allow a writing client to immediately read its own write, even when the client writes to a non-master region

The need to take an efficient snapshot of a whole block of records, so the block can be copied for load balancing or fault tolerance purposes

The need to synchronize inserts of records with the same key.

The system provides a key/record store, and has many applications beyond the user database described. For example, the system could be used to track transient session state, connections in a social network, tags in a community tagging site (such as FLICKR), and so on.

Experiments have shown that the system, while slower than a no-consistency scheme, is faster than a block-master or replica-master scheme while preserving consistency.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system storing a distributed hash table;

FIG. 2 is a schematic view of data farm illustrating exemplary server, storage unit, table and record structures;

FIG. 3 is a schematic view of a process for retrieving data from the distributed system;

FIG. 4 is a schematic view of a process for storing data in the distributed system in a master region;

FIG. 5 is a schematic view of a process for storing data in the distributed system in a non-master region; and

FIG. 6 is a schematic view of a process for generating a tablet snapshot in the distributed system.

### DETAILED DESCRIPTION

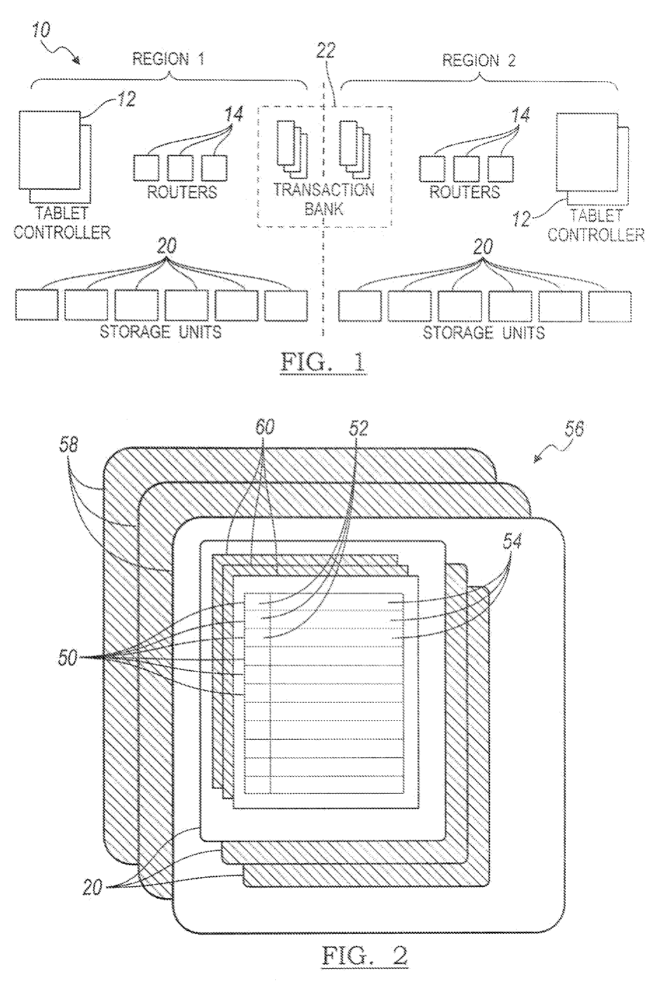

Referring now to FIG. 1, a system embodying the principles of the present invention is illustrated therein and designated at 10. The system 10 may include multiple datacenters that are disbursed geographically across the country or any other geographic region. For illustrative purposes two datacenters are provided in FIG. 1 namely Region 1 and Region 2. Each region may be a scalable duplicate of each other. Each region includes a tablet controller 12, router 14, storage units 20, and a transaction bank 22.

Accordingly, the system 10 provides a hashtable abstraction, implemented by partitioning data over multiple servers and replicating it to multiple geographic regions. An exemplary structure is shown in FIG. 2. Each record 50 is identified by a key 52, and can contain arbitrary data 54. A farm 56 is a cluster of system servers 58 in one region that contain a full replica of a database. Note that while the system 10 includes a “distributed hash table” in the most general sense (since it is a hash table distributed over many servers) it should not be confused with peer-to-peer DHTs, since the system 10 (FIG. 1) has many centralized aspects; for example, message routing is done by specialized routers 14, not the storage units 20 themselves.

The basic storage unit of the system 10 is the tablet 60. A tablet 60 contains multiple records 50 (typically thousands or tens of thousands). However, unlike tables of other systems (which clusters records in order by primary key), the system 10 hashes a record's key 52 to determine its tablet 60. The hash table abstraction provides fast lookup and update via the hash function and good load-balancing properties across tablets 60.

The system 10 offers four fundamental operations: put, get, remove and scan. The put, get and remove operations can apply to whole records, or individual attributes of record data. The scan operation provides a way to retrieve the entire contents of the tablet 60, with no ordering guarantees.

The storage units 20 are responsible for storing and serving multiple tablets 60. Typically a storage unit 20 will manage hundreds or even thousands of tablets 60, which allows the system 10 to move individual tablets 60 between servers 58 to achieve fine-grained load balancing. The storage unit 20 implements the basic application programming interface (API) of the system 10 (put, get, remove and scan), as well as another operation: snapshot-tablet. The snapshot-tablet operation produces a consistent snapshot of a tablet 60 that can be transferred to another storage unit 20. The snapshot-tablet operation is used to copy tablets 60 between storage units 20 for load balancing. Similarly, after a failure, a storage unit 20 can recover lost data by copying tablets 60 from replicas in a remote region.

The assignment of the tablets 60 to the storage units 20 is managed by the tablet controller 12. The tablet controller 12 can assign any tablet 60 to any storage unit 20, and change the assignment at will, which allows the tablet controller 12 to move tablets 60 as necessary for load balancing. However, note that this “direct mapping” approach does not preclude the system 10 from using a function-based mapping such as consistent hashing, since the tablet controller 12 can populate the mapping using alternative algorithms if desired. To prevent the tablet controller 12 from being a single point of failure, the tablet controller 12 may be implemented using paired active servers.

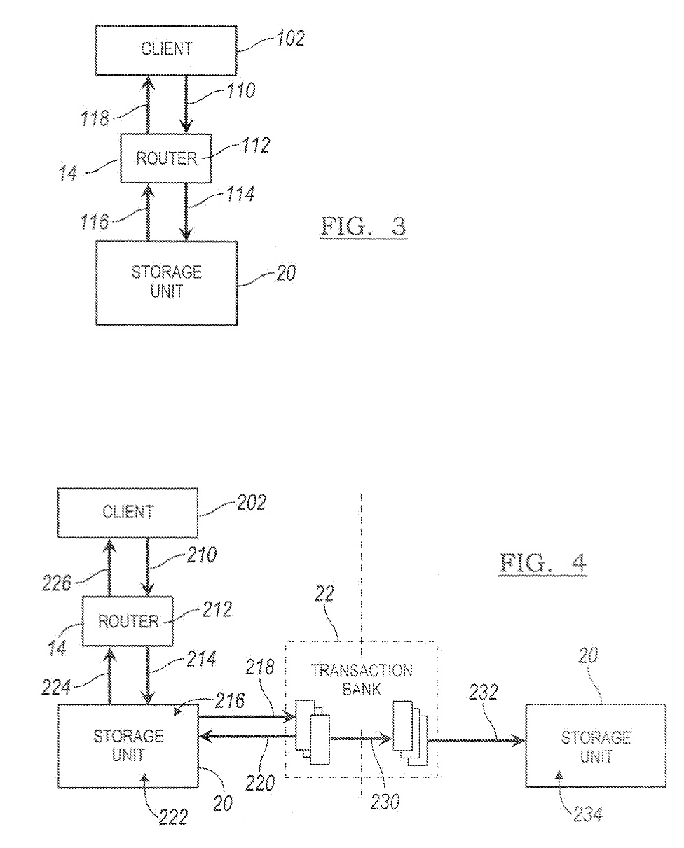

In order for a client to read or write a record, the client must locate the storage unit 20 holding the appropriate tablet 60. The tablet controller 12 knows which storage unit 20 holds which tablet 60. In addition, clients do not have to know about the tablets 60 or maintain information about tablet locations, since the abstraction presented by the system API deals with the records 50 and generally hides the details of the tablets 60. Therefore, the tablet to storage unit mapping is cached in a number of routers 14, which serve as a layer of indirection between clients and storage units 20. As such, the tablet controller 12 is not a bottleneck during data access. The routers 14 may be application-level components, rather than IP-level routers. As shown in FIG. 3, a client 102 contacts any local router 14 to initiate database reads or writes. The client 102 requests a record 50 from the router 14, as denoted by line 110. The router 14 will apply the hash function to the record's key 52 to determine the appropriate tablet identifier (“id”), and look the tablet id up in its cached mapping to determine the storage unit 20 currently holding the tablet 60, as denoted by reference numeral 112. The router 14 then forwards the request to the storage unit 20, as denoted by line 114. The storage unit 20 then executes the request. In the case of a get operation, the storage unit 20 returns the data to the router 14, as denoted by line 116. The router 114 then forwards the data to the client as denoted by line 118. In the case of a put, the storage unit 20 initiates a write consistency protocol, which is described in more detail later.

In contrast, a scan operation is implemented by contacting each storage unit 20 in order (or possibly in parallel) and asking them to return all of the records 50 that they store. In this way, scans can provide as much throughput as is possible given the network connections between the client 102 and the storage units 20, although no order is guaranteed since records 50 are scattered effectively randomly by the record mapping hash function.

For get and put functions, if the router's tablet-to-storage unit mapping is incorrect (e.g. because the tablet 60 moved to a different storage unit 20), the storage unit 20 returns an error to the router 14. The router 14 could then retrieve a new mapping from the tablet controller 12, and retry its request to the new storage unit. However, this means after tablets 60 move, the tablet controller 12 may get flooded with requests for new mappings. To avoid a flood of requests, the system 10 can simply fail requests if the router's mapping is incorrect, or forward the request to a remote region. The router 14 can also periodically poll the tablet controller 12 to retrieve new mappings, although under heavy workloads the router 14 will typically discover the mapping is out-of-date quickly enough. This “router-pull” model simplifies the tablet controller 12 implementation and does not force the system 10 to assume that changes in the tablet controller's mapping are automatically reflected at all the routers 14.

In one implementation, the record-to-tablet hash function uses extensible hashing, where the first N bits of a long hash function are used. If tablets 60 are getting too large, the system 10 may simply increment N, logically doubling the number of tablets 60 (thus cutting each tablet's size in half). The actual physical tablet splits can be carried out as resources become available. The value of N is owned by the tablet controller 12 and cached at the routers 14.

Referring again to FIG. 1, the transaction bank 22 has the responsibility for propagating updates made to one record to all of the other replicas of that record, both within a farm and across farms. The transaction bank 22 is an active part of the consistency protocol.

Applications, which use the system 10 to store data, expect that updates written to individual records will be applied in a consistent order at all replicas. Because the system 10 uses asynchronous replication, updates will not be seen immediately everywhere, but each record retrieved by a get operation will reflect a consistent version of the record.

As such, the system 10 achieves per-record, eventual consistency without sacrificing fast writes in the common case. Because of extensible hashing, records 50 are scattered essentially randomly into tablets 60. The result is that a given tablet typically consists of different sets of records whose writes usually come from different regions. For example, some records are frequently written in the east coast farm, while other records are frequently written in the west coast farm, and yet other records are frequently written in the European farm. The system's goal is that writes to a record succeed quickly in the region where the record is frequently written.

To establish quick updates the system 10 implements two principles: 1) the master region of a record is stored in the record itself, and updated like any other field, and 2) record updates are “committed” by publishing the update to the transaction bank 22. The first aspect, that the master region is stored in the record 50, seems straightforward, but this simple idea provides surprising power. In particular, the system 10 does not need a separate mechanism, such as a lock server, lease server or master directory, to track who is the master of a data item. Moreover, changing the master, a process requiring global coordination, is no more complicated than writing an update to the record 50. The master serializes all updates to a record 50, assigning each a sequence number. This sequence number can also be used to identify updates that have already been applied and avoid applying them twice.

Secondly, updates are committed by publishing the update to the transaction bank 22. There is a transaction bank broker in each datacenter that has a farm; each broker consists of multiple machines for failover and scalability. Committing an update requires only a fast, local network communication from a storage unit 20 to a broker machine. Thus, writes in the master region (the common case) do not require cross-region communication, and are low latency.

The transaction bank 22 provides the following features even in the presence of single machine, and some multiple machine, failures:

An update, once accepted as published by the transaction bank 22, is guaranteed to be delivered to all live subscribers.

An update is available for re-delivery to any subscriber until that subscriber confirms the update has been consumed.

Updates published in one region on a given topic will be delivered to all subscribers in the order they were published. Thus, there is a per-region partial ordering of messages, but not necessarily a global ordering.

These properties allow the system 10 to treat the transaction bank 22 as a reliable redo log: updates, once successfully published, are considered committed. Per region message ordering is important, because it allows us to publish a “mark” on a topic in a region, so that remote regions can be sure, when the mark message is delivered, that all messages from that region published before the mark have been delivered. This will be useful in several aspects of the consistency protocol described below.

By pushing the complexity of a fault tolerant redo log into the transaction bank 22 the system 10 can easily recover from storage unit failures, since the system 10 does not need to preserve any logs local to the storage unit 20. In fact, the storage unit 20 becomes completely expendable; it is possible for a storage unit 20 to permanently and unrecoverably fail and for the system 10 to recover simply by bringing up a new storage unit and populating it with tablets copied from other farms, or by reassigning those tablets to existing, live storage units 20.

However, the consistency scheme requires the transaction bank 22 to be a reliable keeper of the redo log. However, any implementation that provides the above guarantees can be used, although custom implementations may be desirable for performance and manageability reasons. One custom implementation may use multi-server replication within a given broker. The result is that data updates are always stored on at least two different disks; both when the updates are being transmitted by the transaction bank 22 and after the updates have been written by storage units 20 in multiple regions. The system 10 could increase the number of replicas in a broker to achieve higher reliability if needed.

In the implementation described above, there may be a defined topic for each tablet 60. Thus, all of the updates to records 50 in a given tablet are propagated on the same topic. Storage units 20 in each farm subscribe to the topics for the tablets 60 they currently hold, and thereby receive all remote updates for their tablets 60. The system 10 could alternatively be implemented with a separate topic per record 50 (effectively a separate redo log per record) but this would increase the number of topics managed by the transaction bank 22 by several orders of magnitude. Moreover, there is no harm in interleaving the updates to multiple records in the same topic.

Unlike the get operation, the put and remove operations are update operations. The sequence of messages is shown in FIG. 4. The sequence shown considers a put operation to record rᵢ that is initiated in the farm that is the current master of rᵢ. First, the client 202 sends a message containing the record key and the desired updates to a router 14, as denoted by line 21. As with the get operation, the router 14 hashes the key to determine the tablet and looks up the storage unit 20 currently holding that tablet as denoted by reference numeral 212. Then, as denoted by line 214, the router 14 forwards the write to the storage unit 20. The storage unit 20 reads a special “master” field out of its current copy of the record to determine which region is the master, as denoted by reference number 216. In this case, the storage unit 20 sees that it is in the master farm and can apply the update. The storage unit 20 reads the current sequence number out of the record and increments it. The storage unit 20 then publishes the update and new sequence number to the local transaction bank broker, as denoted by line 218. Upon receiving confirmation of the publish, as denoted by line 220, the storage unit 20, considers the update committed. The storage unit 20 writes the update to its local disk, as denoted by reference numeral 222. The storage unit 20 returns success to the router 14, which in turn returns success to the client 202, denoted by lines 224 and 226, respectively.

Asynchronously, the transaction bank 22 propagates the update and associated sequence number to all of the remote farms, as denoted by line 230. In each farm, the storage units 20 receive the update, as denoted by line 232, and apply it to their local copy of the record, as denoted by reference number 234. The sequence number allows the storage unit 20 to verify that it is applying updates to the record in the same order as the master, guaranteeing that the global ordering of updates to the record is consistent. After applying the record, the storage unit 20 consumes the update, signaling the local broker that it is acceptable to purge the update from its log if desired.

Now consider a put that occurs in a non-master region. An exemplary sequence of messages is shown in FIG. 5. The client 302 sends the record key and requested update to a router 14 (as denoted by line 310), which hashes the record key (as denoted by numeral 312) and forwards the update to the appropriate storage unit 20 (as denoted by line 314). As before, the storage unit 20 reads its local copy of the record (as denoted by numeral 316), but this time it finds that it is not in the master region. The storage unit 20 forwards the update to a router 14 in the master region as denoted by line 318. All the routers 14 may be identified by a per-farm virtual IP, which allows anyone (clients, remote storage units, etc.) to contact a router 14 in an appropriate farm without knowing the actual IP of the router 14. The process in the master region proceeds as described above, with the router hashing the record key (320) and forwarding the update to the storage unit 20 (322). Then, the storage unit 20 publishes the update 324, receives a success message (326), writes the update to a local disk (328), and returns success to the router 14 (330). This time, however, the success message is returned to the initiating (non-master) storage unit 20 along with a new copy of the record, as denoted by line 332. The storage unit 20 updates its copy of the record based on the new record provided from the master region, which then returns success to the router 14 and on to the client 302, as denoted by lines 334 and 336, respectively.

Further, the transaction bank 22 asynchronously propagates the update to all of the remote farms, as denoted by line 338. As such, the transaction bank eventually delivers the update and sequence number to the initiating (non-master) storage unit 20.

The effect of this process is that regardless of where an update is initiated, it is always processed by the storage unit 20 in the master region for that record 50. This storage unit 20 can thus serialize all writes to the record 50, assigning a sequence number and guaranteeing that all replicas of the record 50 see updates in the same order.

The remove operation is just a special case of put: it is a write that deletes the record 50 rather than updating it and is processed in the same way as put. Thus, deletes are applied as the last in the sequence of writes to the record 50 in all replicas.

A basic algorithm for ensuring the consistency of record writes has been described. Above, however, there are several complexities which must be addressed to complete this scheme. For example, it is sometimes necessary to change the master replica for a record. In one scenario, a user may move from Georgia to California. Then, the access pattern for that user will change from the most accesses going to the east coast datacenter to the most accesses going to the west coast datacenter. Writes for the user on the west coast will be slow until the user's record mastership moves to the west coast.

In the normal case (e.g., in the absence of failures), mastership of a record 50 changes simply by writing the name of the new master region into the record 50. This change is initiated by a storage unit 20 in a non-master region (say, “west coast”) which notices that it is receiving multiple writes for a record 50. After a threshold number of writes is reached, the storage unit 20 sends a request for the ownership to the current master (say, “east coast”). In this example, the request is just a write to the “master” field of the record 50 with the new value “west coast.” Once the “east coast” storage unit 20 commits this write, it will be propagated to all replicas like a normal write so that all regions will reliably learn of the new master. The mastership change is also sequenced properly with respect to all other writes; writes before the mastership change go to the old master, writes after the mastership change will notice that there is a new master and be forwarded appropriately (even if already forwarded to the old master). Similarly, multiple mastership changes are also sequenced; one mastership change is strictly sequenced after another at all replicas, so there is no inconsistency if farms in two different regions decide to claim mastership at the same time.

After the new master claims mastership by requesting a write to the old master, the old master returns the version of the record 50 containing the new master's identity. In this way, the new master is guaranteed to have a copy of the record 50 containing all of the updates applied by the old master (since they are sequenced before the mastership change.) Returning the new copy of a record after a forwarded write is also useful for “critical reads,” described below.

This process requires that the old master is alive, since it applies the change to the new mastership. Dealing with the case where the old master has failed is described further below. If the new master storage unit falls, the system 10 will recover in the normal way, by assigning the failed storage unit's tablets 60 to other servers in the same farm. The storage unit 20 which receives the tablet 60 and record 50 experiencing the mastership change will learn it is the master either because the change is already written to the tablet copy the storage unit 20 uses to recover, or because the storage unit 20 subscribes to the transaction bank 22 and receives the mastership update.

When a storage unit 20 fails, it can no longer apply updates to records 50 for which it is the master, which means that updates (both normal updates and mastership changes) will fail. Then, the system 10 must forcibly change the mastership of a record 50. Since the failed storage unit 20 was likely the master of many records 50, the protocol effectively changes the mastership of a large number of records 50. The approach provided is to temporarily re-assign mastership of all the records previously mastered by the storage unit 20, via a one-message-per-tablet protocol. When the storage unit 20 recovers, or the tablet 60 is reassigned to a live storage unit 20, the system 10 rescinds this temporary mastership transfer.

The protocol works as follows. The tablet controller 12 periodically pings storage units 20 to detect failures, and also receives reports from the router 14 unable to contact a given storage unit. When the tablet controller 12 learns that a storage unit 20 has failed, it publishes a master override message for each tablet held by the failed storage unit on that tablet's topic. In effect, the master override message says “AH records in tablet tᵢ that used to be mastered in region R will be temporarily mastered in region R′.”

All storage units 20 in all regions holding a copy of tablet t₁ will receive this message and store an entry in a persistent master override table. Any time a storage unit 20 attempts to check the mastership of a record, it will first look in its master override table to see if the master region stored in the record has been overridden. If so, the storage unit 20 will treat the override region as the master. The storage unit in the override region will act as the master, publishing new updates to the transaction bank 22 before applying them locally. Unfortunately, writes in the region with the failed master storage unit will fail, since there is no live local storage unit that knows the override master region. The system 10 can deal with this by having routers 14 forward failed writes to a randomly chosen remote region, where there is a storage unit 20 that knows the override master. An optimization which may also be implemented includes storing master override tables in the router 14, so failed writes can be forwarded directly to the override region.

Note that since the override message is published via the transaction bank 22, it will be sequenced after all updates previously published by the now failed storage unit. The effect is that no updates are lost; the temporary master will apply all of the existing updates before learning that it is the temporary override master and before applying any new updates as master.

At some point, either the failed storage unit will recover or the tablet controller 12 will reassign the failed unit's tablets to live storage units 20. A reassigned tablet 60 is obtained by copying it from a remote region. In either case, once the tablet 60 is live again on a storage unit 20, that storage unit 20 can resume mastership of any records for which mastership had been overridden. The storage unit 20 publishes a rescind override message for each recovered tablet. Upon receiving this message, the override master resumes forwarding updates to the recovered master instead of applying them locally. The override master will also publish an override rescind complete message for the tablet; this message marks the end of the sequence of updates committed at the override master. After receiving the override rescind complete message, the recovered master knows it has applied all of the override master's updates and can resume applying updates locally. Similarly, other storage units that see the rescind override message can remove the override entry from their override tables, and revert to trusting the master region listed in the record itself.

After a write in a non-master region, readers in that region will not see the update until it propagates back to the region via the transaction bank 22. However, some applications of the system 10 expect writers to be able to immediately see their own writes. Consider for example a user that updates a profile with a new set of interests and a new email address; the user may then access the profile (perhaps just by doing a page refresh) and see that the changes have apparently not taken effect. Similar problems can occur in other applications that may use the system 10; for example a FLICKR user that tags a photo expects that tag to appear in subsequent displays of that photo.

A critical read is a read of an update by the same client that wrote the update. Most reads are not critical reads, and thus it is usually acceptable for readers to see an old, though consistent, copy of the data. It is for this reason that asynchronous replication and weak consistency are acceptable. However, critical reads require a stronger notion of consistency; the client does not have to see the most up-to-date version of the record, but it does have to see a version that reflects its own write.

To support critical reads, when a write is forwarded from a non-master region to a master region, the storage unit in the master region returns the whole updated record to the non-master region. A special flag in the put request indicates to the storage unit in the master region that the write has been forwarded, and that the record should be returned. The non-master storage unit writes this updated record to disk before returning success to the router 14 and then on to the client. Now, subsequent reads from the client in the same region will see the updated record, which includes the effects of its own write. Incidentally other readers in the same region will also see the updated record.

Note that the non-master storage unit has effectively “skipped ahead” in the update sequence, writing a record that potentially includes multiple updates that it has not yet received via its subscription to the transaction bank 22. To avoid “going back in time,” a storage unit 20 receiving updates from the transaction bank 22 can only apply updates with a sequence number larger than that stored in the record.

The system 10 does not guarantee that a client which does a write in one region and a read in another will see their own write. This means that if a storage unit 20 in one region fails, and readers must go to a remote region to complete their read, they may not see their own update as they may pick a non-master region where the update has not yet propagated. To address this, the system 10 provides a master read flag in the API. If a storage unit 20 that is not the master of a record receives a forwarded “critical read” get request, it will forward the request to the master region instead of serving the request itself. If, by unfortunate coincidence, both the storage unit 20 in the readers region and the storage unit 20 in the master region fail, the read will fail until an override master takes over and guarantees that the most recent version of the record is available.

it is often necessary to copy a tablet 60 from one storage unit 20 to another, for example to balance load or recover after a failure. In each case, the system 10 ensures that no updates are lost: each update must either be applied on the source storage unit 20 before the tablet 60 is copied, or on the destination storage unit 20 after the copy. However, the asynchronous, nature of updates makes it difficult to know if there are outstanding updates “inflight” when the system 10 decides to copy a tablet 60. When the destination storage unit 20 subscribes to the topic for the tablet 60, it is only guaranteed to receive updates published after the subscribe message. Thus, if an update is in-flight at the time of subscribe, it may not be applied in time at the source storage unit 20, and may not be applied at all at the destination.

The system 10 could use a locking scheme in which all updates are halted to the tablet 60 in any region, in flight updates are applied, the tablet 60 is transferred, and then the tablet 60 is unlocked. However, this has two significant disadvantages: the need for a global lock manager, and the long duration during which no record in the tablet 60 can be written.

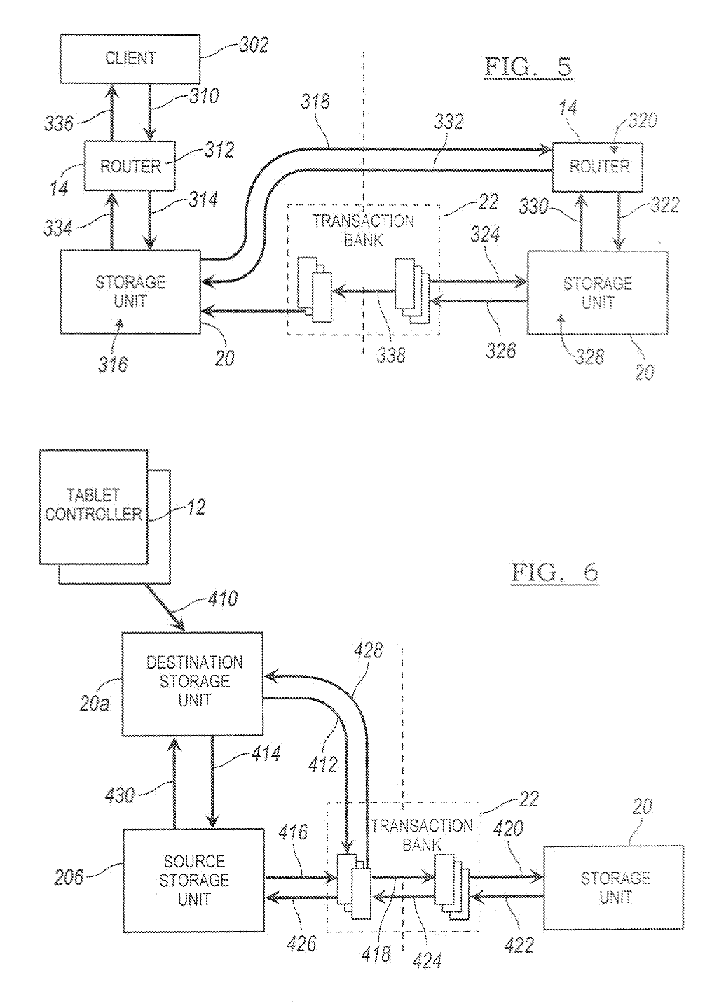

Instead, the system 10 may use the transaction bank middleware to help produce a consistent snapshot of the tablet 60. The scheme, shown in FIG. 6, works as follows. First, the tablet controller 12 tells the destination storage unit 20a to obtain a copy of the tablet 60 from a specified source in the same or different region, as denoted by line 410. The destination storage unit 20a then subscribes to the transaction manager topic for the tablet 60 by contacting the transaction bank 22, as denoted by line 412. Next the destination storage unit 20a contacts the source storage unit 20b and requests a snapshot, as denoted by line 414.

To construct the snapshot, the source storage unit 20b publishes a request tablet mark message on the tablet topic through the transaction bank 22, as denoted by lines 416, 418, and 420. This message is received in all regions by storage units 20 holding a copy of the tablet 60. The storage units 20 respond by publishing a mark tablet message on the tablet topic as denoted by lines 422 and 424. The transaction bank 22 guarantees that this message will be sequenced after any previously published messages in the same region on the same topic, and before any subsequently published messages in the same region on the same topic. Thus, when the source storage unit 20b receives the mark tablet message from all of the other regions, as denoted by line 426, it knows it has applied any updates that were published before the mark tablet messages. Moreover, because the destination storage unit 20a subscribes to the topic before the request tablet mark message, it is guaranteed to hear all of the subsequent mark tablet messages, as denoted by line 428. Consequently, the destination storage unit is guaranteed to hear and apply all of the updates applied in a region after that region's mark tablet message. As a result, all updates before the mark are definitely applied at the source storage unit 20b, and all updates after the mark are definitely applied at the destination storage unit 20a. The source storage unit 20b may hear some extra updates after the marks, and the destination storage unit 20a may hear some extra updates before the marks, but in both cases these extra updates can be safely ignored.

At this point, the source storage unit 20b can make a snapshot of the tablet 60, and then begin transferring the snapshot, as denoted by line 430. When the destination completely receives the snapshot, it can apply any updates received from the transaction bank 22. Mote that the tablet snapshot contains mastering information, both the per-record masters and any applicable tablet-level master overrides.

Inserts pose a special difficulty compared to updates. If a record 50 already exists, then the storage unit 20 can look in the record 50 to see what the master region is. However, before a record 50 exists it cannot store a master region. Without a master region to synchronize inserts, it is difficult for the system 10 to prevent two clients in two different regions from inserting two records with the same key but different data, causing inconsistency.

To address this problem, each tablet 60 is given a tablet-level master region when it is created. This master region is stored in a special metadata record inside the tablet 60. When a storage unit 20 receives a put request for a record 50 that did not previously exist, it checks to see if it is in the master region for the tablet 60. If so, it can proceed as if the insert were a regular put, publishing the update to the transaction bank 22 and then committing it locally. If the storage unit 20 is not in the master region, it must forward the insert request to the master region for insertion.

Unlike record-level updates which have affinity for a particular region, inserts to a tablet 60 can be expected to be uniformly spread across regions. Accordingly, the hashing scheme will group into one tablet records that are inserted in several regions. Unless the whole application does most of its inserts in one region. For example, for a tablet 60 replicated in three regions, two-thirds of the inserts can be expected to come from non-master regions. As a result, inserts to the system 10 are likely to have higher average latency than updates.

The implementation described uses a tablet mastering scheme, but allows the application to specify a flag to ignore the tablet master on insert. This means the application can elect to always have low-latency inserts, possibly using an application-specific mechanism for ensuring that inserts only occur in one region to avoid inconsistency.

To test the system 10 described above, a series of experiments have been run to evaluate the performance of the update scheme compared to alternative schemes. In particular, the following items have been compared:
No master—updates are applied directly to a local copy of the data in whatever region the update originates, possibly resulting in inconsistent data
Record master—scheme where mastership is assigned per record
Tablet master—mastership is assigned at the tablet level
Replica master—one whole database replica is assigned as the master

The experimental results show that record mastering provides significant performance benefits compared to tablet or replica mastering; for example, record level mastering in some cases results in 85 percent less latency for updates than tablet mastering. Although, more expensive than no mastering, the record scheme still performs well. The cost of inserting data, supporting critical reads, and changing mastership were also examined.

The system 10 has been implemented both as a prototype using the ODIN distributed systems toolkit, and as a production-ready system. The production-ready system is implemented and undergoing testing, and will enter production in this year. The experiments were run using the ODIN-based prototype for two reasons. First, it allowed several different consistency schemes to be tested; it isolated production code from alternate schemes that would not be used in production. Second, ODIN allows the prototype code to be run, unmodified, inside a simulation environment, to drive simulated servers and network messages. Therefore, using ODIN hundreds of machines can be simulated without having to obtain and provision all of the required machines.

The simulated system consisted of three regions, each containing a tablet controller 12, transaction bank broker, five routers 14 and fifty storage units 20. The storage in each storage unit 20 is implemented as an instance of BerkeleyDB. Each storage unit was assigned an average of one hundred tablets.

The data used in the experiments was generated using the dbgen utility from the TPC-H benchmark. A TPC-H customer table was generated with 10.5 million records, for an average of 2,100 records per tablet. The customer table is the closest analogue in the TPC-H schema of a typical user database. Using TPC-H instead of an actual user database avoids user privacy issues, and helps make the results more reproducible by others. The average customer record size was 175 bytes. Updates were generated by randomly selecting a customer record according to a Zipfian distribution, and applying a change to the customer's account balance. A Zipfian distribution was used because several real workloads, especially web workloads, follow a Zipfian distribution.

In the simulation, all of the customer records were inserted (at a rate of 100 per simulated second) into a randomly chosen region. All of the updates were then applied (also at a rate of 100 per simulated second). Updates were controlled by a simulation parameter called regionaffinity (0≦regionaffinity≦1). Where probability was equal to regionaffinity, the update was initiated in the same region where the record was inserted. Where with probability equal to 1-regionaffinity the update was initiated in a randomly chosen region different from the insertion region. For the record master scheme, the record's master region was the region the record was inserted. For the tablet master scheme, the tablet's master region was set as the region where the most updates are expected, based on analysis of the workload. A real system could detect the write pattern online to determine tablet mastership. For the replica master scheme, the central region was chosen as the master since it had the lowest latency to the other regions.

The latency of each insert and update was measured and the average bandwidth used. To provide realistic latencies, the latencies were measured within a datacenter using the prototype. The average time to transmit and apply an update to a storage unit was approximately 1 ms. Therefore, 1 ms was used as the intra-datacenter latency. For inter-datscenter latencies, the latencies from the publicly-available Harvard PlanetLab ping dataset were used. We used pings from Stanford to MIT (92.0 ms) were used to represent west coast to east coast latency, Stanford to U. Texas (46.4 ms) for west coast to central, and U. Texas to MIT (51.1 ms) for central to east coast.

TABLE 1

| | Min | | | Average |
|---|---|---|---|---|
| Scheme | latency | Max latency | Average latency | bandwidth |
| No master | 6 ms | 6 ms | 6 ms | 2.09 KB |
| Record master | 6 ms | 192 ms | 18.6 ms | 2.16 KB |
| Tablet master | 6 ms | 192 ms | 54.2 ms | 2.31 KB |
| Replica master | 6 ms | 110 ms | 72.7 ms | 2.48 KB |

First the cost to commit an update was examined. In the earliest experiments critical reads or changing the record master were not supported. Experiments with critical reads and changing the record master are described below. Initially, regionaffinity=0.9: that is, 90 percent of the updates originated in the same region as where the record was inserted. The resulting update latencies are shown in Table 1. As the table shows, the no master scheme achieves the lowest latency. Since writes commit locally, the latency is only the cost of three hops (client to router 14, to storage unit 20, to transaction bank 22, each 2 ms roundtrip). Of the schemes that guarantee consistency, the record master scheme has the lowest latency, with a latency that is 66 percent less than the tablet master scheme and 74 percent less than replica mastering. The record master scheme is able to update a record locally, and only requires a cross-region communication for the 10 percent of updates that are made in the non-master region. In contrast, in the tablet master scheme the majority of updates for a tablet occur in a non-master region, and are generally forwarded between regions to be committed. The replica master causes the largest latency, since all updates go to the central region, even if the majority of updates for a given tablet occur in a specific region. In the record and tablet master schemes, the maximum latency of 192 ms reflects the cost of a round-trip message between the east and west cost; this maximum latency occurs far less frequently in the record-mastering scheme. For replica mastering, the maximum latency is only 110 ms, since the central region is “in-between” the east and west coast regions.

Table 1 also shows the average bandwidth per update, representing both inline cost to commit the update, and asynchronous cost to replicate updates via the transaction bank 22. The differences between schemes are not as dramatic as in the latency case, varying from 3.5 percent (record versus no mastering) to 7.4 percent (replica versus tablet mastering). Messages forwarded to a remote region, in any mastering scheme, add a small amount of bandwidth usage, but as the results show, the primary cost of such long distance messages is latency.

In a wide-area replicated database, it is a challenge to ensure updates are consistent. As such, a system has been provided herein where the master region for updates is assigned on a record-by-record basis, and updates are disseminated to other regions via a reliable publication/subscription middleware. The system makes the common case (repeated writes in the same region) fast, and the general case (writes from different regions) correct, in terms of the weak consistency model. Further mechanisms have been described for dealing with various challenges, such as the need to support critical reads and the need to transfer mastership. The system has been implemented, and data from simulations have been provided to show that it is effective at providing high performance updates.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for maintaining a database and providing access for a client, the system comprising:
a storage unit including a plurality of tablets forming a hash table, each tablet of the plurality of tablets comprising a plurality of records;
a tablet controller configured to maintain a relationship between each tablet and the storage unit;
a router configured to hash a record's key to determine the tablet associated with each record and distribute messages from clients to the storage units thereby serving as a layer of indirection; and
a transaction bank configured to propagate updates made to one record to all other replicas of the record.

2. The system according to claim 1, wherein a field indicating a master region of each record is stored in each record itself.

3. The system according to claim 2, wherein the storage unit executes a put operation that accesses a record of the plurality of records and reads the field in the record to determine the master region for the record and forwards the put operation to another router in the master region if the storage unit is not in the master region.

4. The system according to claim 2, wherein the storage unit executes a put operation that accesses a record of the plurality of records and reads the field in the record to determine the master region for the record, updates the record, and posts the put operation to the transaction bank if the storage unit is in the master region.

5. The system according to claim 1 wherein the storage unit is configured to execute a scan operation that accesses each storage unit in order and requests all of the records stored in the storage unit.

6. The system according to claim 1, wherein the storage unit executes a snapshot-tablet operation that produces a consistent snapshot of a tablet that can be transferred to another storage unit.

7. The system according to claim 1, wherein the storage unit commits updates locally in a record and then asynchronously copies updates to other replicas of the record.

8. The system according to claim 1, wherein the storage unit applies updates to a master record and serializes the updates before disseminating the updates to other replicas.

9. The system according to claim 1, wherein the tablet controller is configured to move tablets between storage units for load balancing.

10. The system according to claim 1, wherein the router caches a tablet to storage unit mapping.

11. The system according to claim 1, wherein the router retrieves a new tablet to storage unit mapping from the tablet controller if the storage unit returns an error to the router.

12. The system according to claim 1, wherein the router periodically polls the tablet controller to retrieve a new tablet to storage unit mapping.

13. The system according to claim 1, wherein the router applies a hash function where the first N bits of the hash function are used and the tablet controller increments N to double the number of tablets, if the tablets exceed a predefined size.

14. The system according to claim 1, wherein the storage unit commits updates by publishing the update to the transaction bank.

15. The system according to claim 1, wherein the storage unit serializes all writes to the record by assigning a sequence number to ensure that all replicas of the record see updates in the same order.

16. A method for maintaining a database and providing access for a client, the method comprising the steps of:
storing a plurality of tablets that form a hash table, each tablet of the plurality of tablets comprising a plurality of records;
storing a relationship between each tablet and a storage unit;
hashing a record's key to determine the tablet associated with each record
distributing messages from clients to the storage units using the relationship thereby establishing a layer of indirection;
propagating updates made to one record to all other replicas of the record.

17. The method according to claim 16, committing updates locally in a record and then asynchronously copying updates to other replicas of the record.

18. The method according to claim 16, applying updates to a master record and serializing the updates before disseminating the updates to other replicas.

19. The method according to claim 16, moving tablets between storage units for load balancing.

20. The method according to claim 16, caching a tablet to storage unit mapping.

21. The method according to claim 20, retrieving a new tablet to storage unit mapping from a tablet controller if an error is returned while reading a record.

22. The method according to claim 22, polling a tablet controller to retrieve a tablet to storage unit mapping.
